(19) United States
(12) Patent Application Publication
(10) Pub. No.: US 2008/0238336 A1
(43) Pub. Date: Oct. 2, 2008

(54) Back-Light Devices and Displays Incorporating Same

(75) Inventors: Huajun Peng, Hong Kong (CN); Kwan Wah Ng, Hong Kong (CN); Chen-Jung Tsai, Hong Kong (CN)

Correspondence Address: BUCHANAN, INGERSOLL & ROONEY PC, POST OFFICE BOX 1404, ALEXANDRIA, VA, 22313-1404, US

(73) Assignee: Hong Kong Applied Science and Technology Research, Horn Kong (CN)

(21) Appl. No.: 11/693,583

(22) Filed: Mar. 29, 2007

(51) Int. Cl. H05B 37/02

(52) U.S. Cl. 315/294

(57) ABSTRACT

A back-light arrangement for providing back-light to a display panel such as a liquid crystal video display panel, includes a plurality of light emitting devices arranged and distributed for providing back-light to the display panel, and electronic circuitry arranged for driving the plurality of light emitting devices to produce the back-light. The electronic circuitry contains a plurality of drivers, each of which is arranged to individually drive a corresponding one of the plurality of light emitting devices to emit light upon receipt of an actuating signal. A controller is arranged to multiplex an intensity signal to each one of the plurality of drivers for individually driving each one of the plurality of light emitting devices.

### FIELD OF THE INVENTION

This invention relates to back-light devices for an image display, and more particularly, to back-light devices for a liquid crystal display and a liquid crystal display comprising back-light devices. More specifically, although not solely limited thereto, this invention relates to a back-light device comprising a plurality of distributed light-emitting diodes (LEDs) and a liquid display comprising same.

### BACKGROUND OF THE INVENTION

Liquid crystal displays (LCD) have been increasingly used in display applications, for example, in televisions and computer monitors. The operation of an LCD video display panel typically requires a back-light device to illuminate an LCD panel from the backside of the LCD panel to facilitate image display, since liquid crystal itself does not generate light, but only passes or impedes the passage of light.

With the ever increasing demand on displays having a high image resolution, the number of pixels, or the pixel density which is the number of pixel per unit area, of a video display is also ever increasing. Typically, the pixels of an image display are arranged as a matrix of pixels which is organised into a plurality of rows and columns of pixels, such as LCD pixels. A video image is formed on a display by sequential line scanning of an image signal. Typically, a picture frame of a video image is formed by projecting an image signal sequentially from the left side to the right side of a display panel, and from the top to the bottom of a display panel, as is known by persons skilled in the art. The formation of an image on an LCD display by line scanning will strike a balance between providing a good quality display image and a reasonable power consumption. In general, video frames are currently formed at a rate of 60 frames-per-second or above, since it is known that a picture refreshing frequency at or above this rate is acceptable to the human eyes. However, a higher resolution means the number of rows of pixels will be ever increasing, and the fraction of time allocated for activation of each row of backlight to an LCD or like displays will be ever decreasing, since the sequential scanning of all the pixel rows will have to be completed within the time allocated for each video frame, that is, typically within 1/60 second or less for most applications. It will be appreciated that this imposes a severe limitation to further enhancing image resolution since the brightness of an backlight device will have to be extremely high in order to produce an appropriate luminance level acceptable for backlighting.

Furthermore, it is also known, for example in US 2005/0231978, that providing selective back-light to a display in accordance with the brightness of an image being displayed will enhance both image contrast and power consumption. For example, providing equal back lighting to a dark image section and a bright image section will make a dark image on a back-illuminated display portion less dark, a bright image less outstanding. Therefore, an equal level of back-light often could mean a waste of power coupled with performance degradation. With the demand for displays of ever increasing resolution, pixel density of an LCD display will keep on increasing and the issues of heat dissipation and image contrast will require particular attention.

Therefore, it is desirable if there can be provided an improved back-light device, and a display incorporating such a back-light device.

### SUMMARY OF THE INVENTION

According to the present invention, there is provided a back-light arrangement for providing back-light to a display panel such as a liquid crystal video display panel, comprising a plurality of light emitting devices arranged and distributed for providing back-light to said display panel; electronic circuitry arranged for driving said plurality of light emitting devices to produce said back-light, wherein said electronic circuitry comprises a plurality of drivers each one of which is arranged to individually drive a corresponding one of said plurality of light emitting devices to emit light upon receipt of an actuating signal; and a controller arranged to multiplex an intensity signal to each one of said plurality of drivers for individually driving each one of said plurality of light emitting devices.

A backlight arrangement comprising a matrix of active drivers makes it possible to configure a driver so that its duration of operation is not entirely dependent on the actual actuation time received by the driver. In addition, the use of a multiplexing scheme, for example, a time division multiplexing scheme, to multiplex an intensity signal to an associated driver will help to mitigate adverse influence to the operation of backlight emitting devices of other, especially adjacent, pixel rows, while benefiting from power saving since the backlight emitting devices are operated as and when necessary.

In an exemplary embodiment, each said driver comprises a current source which is actuatable by a solid state switch, and said solid state switch is actuatable upon receipt of a said actuation signal from said controller. With a solid state switch arranged for the actuation of a current source, the current source can be isolated from the controller or other drivers upon deactivation of the solid state switch, so that inter-driver interference will be mitigated. Furthermore, isolation of the current source from other drivers means that the duration of operation of a driver could be extended independent of the operation of other drivers.

As an example, a capacitive member is coupled to the current source, and the capacitive member is arranged so that the duration of operation of the current source is extendable beyond the duration of the actuation signal. For example, a capacitor may be coupled to the input terminal of the driver or the current source so that the actuation of the driver or current source can be extended.

The current source may be isolatable from the actuation signal upon deactivation of the solid state switch. To facilitate an effective electrical isolation, for example between the controller and the driver when necessary, the solid state switch has a very high impedance upon de-activation.

For example, the current source may comprise a FET which is arranged for supply of a current to said light emit device, and said solid state switch comprises a FET actuatable by said actuation signal, and the capacitive member may be connected to the gate terminal of said FET of said current source.

According to another aspect of the present invention, there is provided a back-light arrangement for providing back-light to a display panel such as a liquid crystal video display panel, comprising a plurality of light emitting devices arranged into an array of a matrix of M columns and N rows, M and N being integers; and electronic circuitry comprising N row rails and M column rails, wherein said light emitting devices belonging to a row of said matrix is associated with a said row rail and said light emitting devices belonging to a column of said matrix is associated with a column rail, said row rails and said column rails being arranged for transmitting actuation signals to said light emitting devices; wherein said electronic circuitry further may comprise a plurality of solid state switches, each said light emitting device may be associated with a first solid state switch and a second solid state switch; wherein said first solid state switch may connect said light emitting device to a power source and is actuatable upon receipt of an actuation signal from said second solid state switch, said second solid states switches may be actuatable only when actuation signals are present on both a said row rail and a said column associated with said second solid state switch.

The use of a pair of solid state switches to cooperatively and selectively operate a light emitting source, such as an LED or an ensemble of LEDs, makes line scanning possible even with an increasing number of pixel rows.

According to another aspect of the present invention, there is provided a back-light arrangement for providing back-light to a display panel such as a liquid crystal video display panel, comprising a plurality of light emitting devices arranged and distributed for providing back-light to said display panel; electronic circuitry arranged for driving said plurality of light emitting devices to produce said back-light, wherein said electronic circuitry comprises a plurality of drivers each one of which is arranged to individually drive a corresponding one of said plurality of light emitting devices to emit light upon receipt of an actuating signal, and wherein the brightness of a said light emitting device is controllable by varying the amplitude of an intensity signal; and a controller arranged to transmit said intensity signal to each one of said plurality of drivers for individually driving each one of said plurality of light emitting devices, wherein the amplitude of each said intensity signal is individually adjustable in response to changes in image intensity distribution on said display panel.

By providing a back-light arrangement in which the brightness of each of the light emitting source is individually controllable, an appropriate level of back-light can be provided to a particular pixel or a pixel region, thereby enhancing image contrast and at the same time mitigating power wastage. This arrangement is also beneficial for a back-light arrangement in which a uniform brightness is required, since the amount of current required to produce a certain brightness is variable among light emitting sources, such as LEDs, due to manufacturing tolerance. By permitting individual brightness control of the light emitting sources, a uniform brightness can be produced by variation of LED drive current.

To provide the intensity signals to the controller, the arrangement may comprise an image intensity analysing device for analysing image intensity distribution information of an image to be displayed on said display panel, wherein said controller adjusts the amplitude of said intensity signals in response to intensity distribution information provided by said image intensity analysing device.

As an example, said light emitting device may be allocated for back-illumination of a pre-determined portion of said display, and the amplitude of a said intensity signal associated with a said light emitting device may increase with the brightness of an image to be displayed on that pre-determined portion of said display panel.

In an embodiment, the intensity signals are arranged into a plurality of intensity signal groups and each signal group comprises a plurality of intensity signals of non-identical amplitudes arranged in time sequence, and wherein the plurality of intensity signals in an intensity signal group are sequentially multiplexed to said plurality of drivers.

Time division multiplexing of the intensity signals (or intensity data) means that the intensity signals are delivered to the drivers only when necessary and this means power saving as well as enhanced contrast due to mitigation of light contamination by unnecessary back-light.

The brightness of each one of said plurality of light emitting devices may be gradually variable by adjusting the amplitude of a said intensity signal associated with said light emitting device. A gradually variable intensity signal means the brightness of a back-light source can closely follow the change of a corresponding image pixel or image pixel portion.

The drivers are actuated in synchronisation with the line scanning signal of a video image to be projected on said display panel.

Each said intensity signal may comprise a pulse of an amplitude determined by said controller.

The intensity signals may be time-multiplexed to each one of said plurality of drivers.

The light emitting devices may be arranged into a matrix of M rows and N columns, M and N being integers; wherein said intensity signals are arranged into M groups each comprising N intensity signals in sequence; and wherein each said intensity signal is a pulse having a duration T of 1/Nf, where f is the number of video frames per second.

Each light emitting device may be configured for back-illumination of a pre-determined portion of said display panel, the brightness level of each said light emitting device being individually controllable by said electronic circuitry responsive to the brightness level of the portion of said display panel being under back-illumination by said light emitting device.

The plurality of light illuminating devices may be configured for back-illumination a liquid crystal display.

Each said light emitting device may comprise at least one light emitting diode.

Each said light emitting device may be within a discrete chip package.

Each light emitting device may comprise a plurality of light emitting diodes within a discrete chip package.

The plurality of light emitting devices may be arranged in a matrix of light emitting diodes.

In an embodiment, the separation between adjacent light emitting devices is uniform.

The driver may be a current source.

A capacitive component may be coupled to said current source for extending duration of illumination of an associated one of said light emitting devices.

The output current of said current source may be controllable by varying the amplitude of said intensity signal.

The current source may comprise a FET in series connection with an associated one of said light emitting source, the amount of current to flow through said FET may be controllable by varying the amplitude of said intensity signal.

In another aspect of the present invention, there is provided a liquid crystal display comprising a back-light arrangement of any of the aforesaid features.

### BRIEF DESCRIPTION OF THE DRAWINGS

Preferred embodiments of the present invention will be explained in further detail below by way of examples and with reference to the accompanying drawings, in which:—

FIG. 1 is a LCD display apparatus comprising a back-light device of the present invention,

FIG. 2 is a schematic block diagram illustrating the signal processing and display components of the apparatus of FIG. 1,

FIG. 3 is a diagram illustrating schematically a back-light device of this invention,

FIG. 4 is a schematic circuit diagram with accompanying timing diagrams illustrating a scheme of multiplexing intensity signals to drivers of the back-light device of FIG. 1,

FIG. 5 is a schematic diagram showing a current source intensity arrangement for the circuit of FIG. 4,

FIGS. 6A & 6B illustrate an exemplary timing relationship between a multiplexing enabling signal and an intensity data group of FIG. 4,

FIGS. 7A & 7B illustrate relationship between capacitor voltage and LED current timing of a driver of FIG. 4,

FIG. 8 illustrates an first exemplary embodiment of a back-light device of this invention, and

FIG. 9 illustrates a second exemplary embodiment of a back-light device of this invention.

### DETAILED DESCRIPTION OF THE PREFERRED EMBODIMENTS

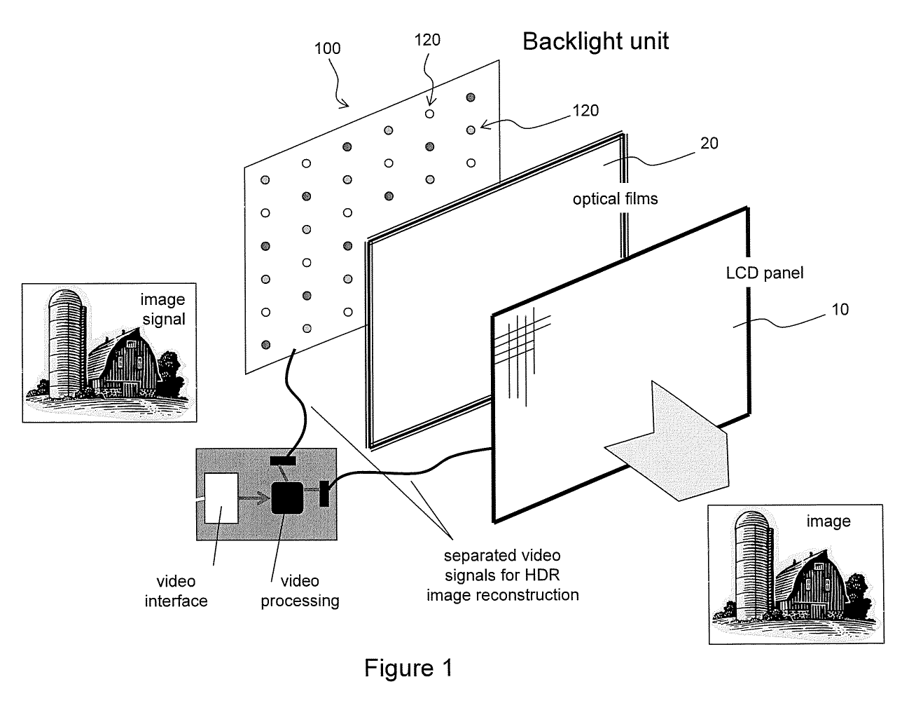

Referring to FIG. 1, there is shown an exemplary video display apparatus comprising an LCD (liquid crystal display) display panel 10 and a back-light device 100 arranged to provide back-light or back-illumination to the LCD panel. The exemplary video display apparatus may be part of a video system, such as a television set, or may be a stand-alone device for connection to a video source in which case a video interface as shown in FIG. 1 is provided. The LCD display panel may comprise an active matrix of LCD pixels and each LCD pixel will pass or impede incident light depending on the instantaneous voltage being applied to the electrodes of that LCD pixel, as is known by persons skilled in the art. For a colour LCD, each pixel usually comprises three sub-pixels, namely, red-, green-, and blue- sub-pixels. Each sub-pixel is usually formed by covering an LCD sub-pixel with an appropriate optical filter, that is, a red-filter for a red sub-pixel and so forth.

Since liquid crystal does not in itself emit light, back-light is provided to make an image on the LCD display visible to a viewer. A back-light for an LCD panel is usually a white light source. In the case of a colour LCD display, a white back-light will be filtered by a colour filter of a sub-pixel to form a sub-pixel of that colour. The output of the sub-pixels will then produce a coloured pixel. The back-light device is located behind the LCD panel and comprises a plurality of light emitting sources (which are light emitting diodes (LED) in this embodiment) arranged into an array of matrix of light sources. To provide a compact and thin display panel, the LEDs are in a discrete chip package. As can be seen in FIG. 1, a plurality of optical films 20 are disposed intermediate the LCD display and the back-light device as is known to persons skilled in the art.

The matrix of light emitting sources 120 is organised into an array of matrix with M columns and N rows so that each light emitting source is responsible for illuminating one of M×N LCD pixels or one of M×N pixel sections on the LCD display. To provide necessary operating conditions or currents for the LEDs, electronic circuitry comprising a plurality of drivers 140 for individually driving each one of the LEDs is provided. The electronic circuitry further comprises a row rail 142 and a column rail 144 which collectively forms a back bone signal switching rail of the driver matrix.

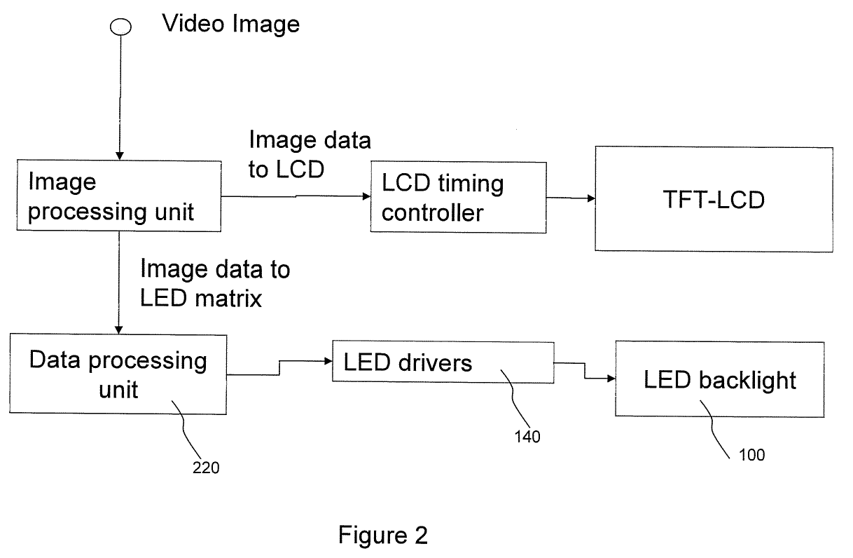

As shown in FIGS. 2, 3, 4 and 5, the drivers 140 are arranged into an array of an M×N driver matrix with each driver associated with a specific and corresponding LED 122 so that each LED is individually driven by a specific driver of a pre-determined row and column. More specifically, an LED (p,q) at row p and column q of the light source matrix is associated with a driver (p,q) also at row p and column q, but of the driver matrix. For example, an LED located at the upper left corner, i.e., LED location (1,1) of the matrix is driven by the driver (1,1). Furthermore, the electronic circuitry comprises a grid of M column rails and N row rails, in which drivers belonging to a specific row are associated with a common row rail, and drivers belonging to a specific column associated with a common column rail. Intensity signals for controlling the brightness of an associated LED are delivered to the drivers via the rail grid to be explained in further detail below.

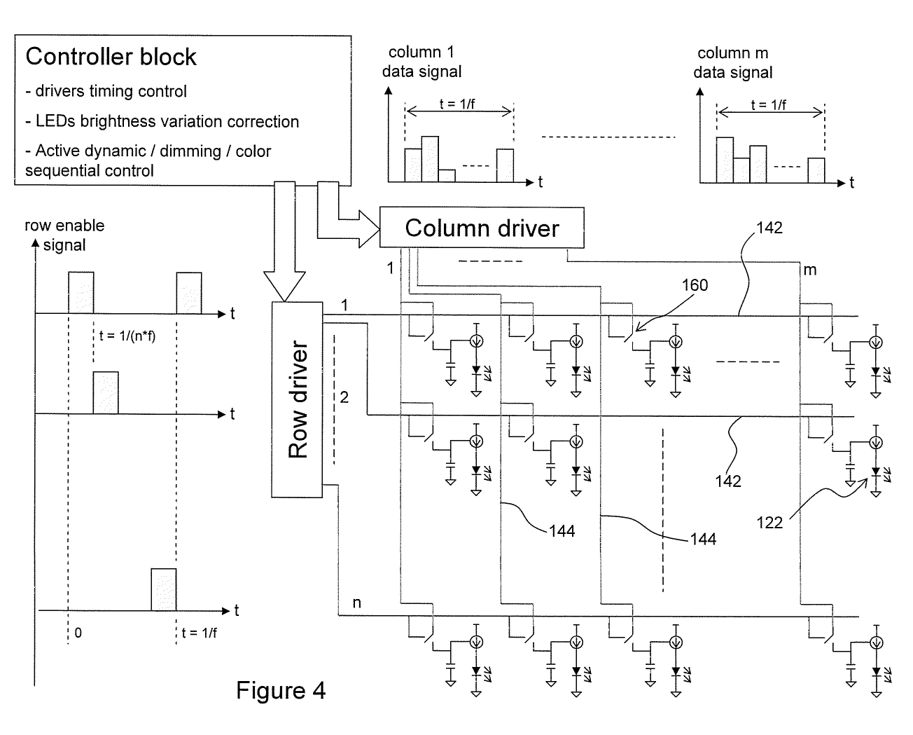

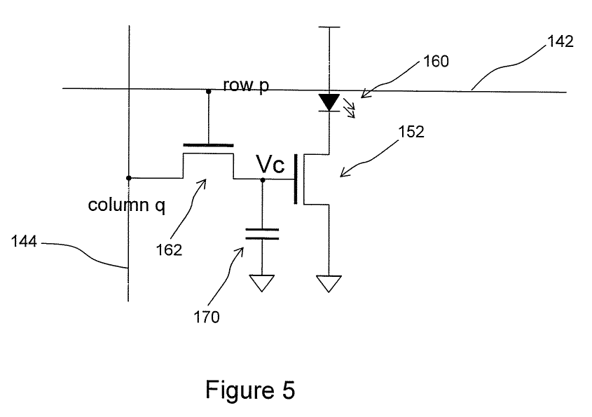

Each driver of FIG. 4 comprises a current source 150 as an example of a driver for supplying operation current to an associated LED. The exemplary current source of FIG. 4 and shown in more detail in FIG. 5, is a single transistor current source comprising a FET 152, for example, a MOSFET, with the drain and source terminals of the FET in series connection with an LED. The operation of the current source is controllable by a 3-terminal semiconductor switch 160, in which a first control terminal of the switch is connected to the row rail, a second control terminal of the switch is connected to the column rail, and a third, or output, terminal of the switch connected to the gate terminal of the FET of the current source. It will be appreciated that when the voltage levels at both the row rail and the column rail are appropriate, the 3-terminal switch, which is a FET 162 in this example, will be turned on and the current source will supply current to operate the LED. On the other hand, when the voltage level at either one or both of the two control terminals of the switch is not at an actuating level, the current source will not operate and the associated LED will not emit light. As shown in FIG. 5, power for providing the operating current to the current source is supplied from outside the rail grid.

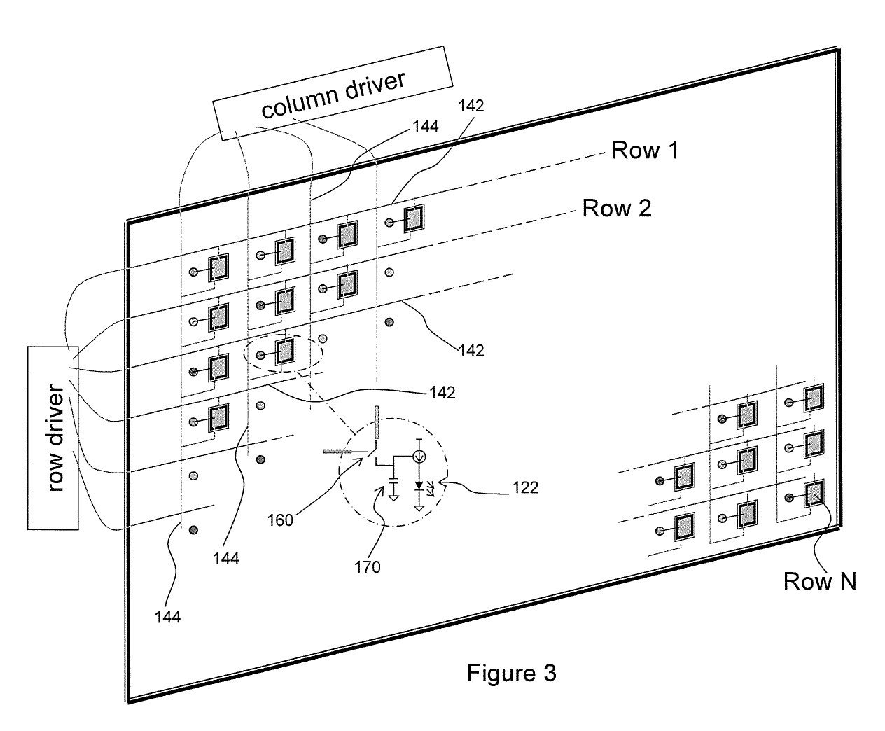

To mitigate the amount of wasted power and to enhance image contrast, each one of the LEDs of this invention is individually driven with an individual intensity data or signal. In addition, the drivers and current sources of this invention are arranged so that the brightness of each individual LED is determined by the amplitude of the intensity signal received by that LED. This is exemplified by the driver and current source arrangement shown FIGS. 3-5 in which it will be noted that a higher amplitude of an intensity signal at terminal 2 of the switch will result in a higher current through the LED, and therefore a higher brightness. By transmitting an intensity signal of appropriate amplitude to the gate terminal of the current source, the brightness of an associated LED could be gradually varied and adjusted. For example, when a dark image is shown at LCD display (1,1), the LED (1,1) could be turned off by sending a “zero” amplitude intensity signal to driver (1,1). One the other hand, when a very bright image is to be displayed at LCD display (1,2), the LED (1,2) could be fully turned on by sending a “maximum” amplitude intensity signal allowable to driver (1,2). Likewise, when the brightness is at an intermediate level, an appropriate intermediate level intensity signal will be sent to an appropriate driver.

In order to provide an individual intensity signal for each individual LED, it will be appreciated that a total of M×N intensity signals or data will be required for each video frame. Although it is possible to transmit all the M×N intensity data to the drivers at the same time, it will be more efficient to time multiplex the intensity data to the drivers since it is known that a video frame is usually formed by sequential line scanning. More particularly, it is known that a video image frame is formed by sequential line scanning, and a complete video frame is formed in a period of time, namely, T, where T=1/f, and f is the frame refreshing frequency, that is, number of video frame per second, as is known to persons skilled in the art. By actuating a driver only when a corresponding image has just been formed or is just to be formed on the LCD display will be more power efficient, as well as minimising possible contamination due to back lighting to an adjacent, non-image forming pixel.

To facilitate multiplexing of the M×N intensity signals onto the individual drivers for back illumination of the M×N LCD pixels or LCD pixel regions, and assuming that the display can be considered as dividing into N rows or N horizontal or axial regions of images, the intensity signals are divided into M groups each comprising N intensity data pulses arranged in a sequence. Since a complete video image frame is formed within the period (T=1/f), all the M×N intensity data must be transmitted to the drivers within the period (T). Furthermore, since a video image frame can be considered as formed by sequential line scanning from row 1 to row N, it will be appreciated that the N rows of LEDs could be sequentially driven without loss of generality.

Referring to FIG. 4, each one of the M groups of intensity signals comprises N intensity data arranged in time sequence. Each one of the N intensity data is a pulse of a pre-determined amplitude and a pulse width t=1/Nf. The intensity data are multiplexed to the drivers sequentially as follows.

When a new video frame starts, an image will be formed by line scanning starting from the top LCD pixel row 1 and finishing at the bottom LCD pixel row N. Since there are a total of N rows of pixels or N rows of pixel sections in a video image frame, the scanning of each row to form a complete image line or row will have to complete in a time of 1/Nf, and the scanning of a second image row will begin at a time of 2/Nf, and etc. By arranging the N data pulses so that the pulse width of each of the data pulses is 1/Nf, or so that the pulse centre spacing between adjacent data pulses is at t=1/Nf, the row intensity data can be multiplexed onto the individual drivers sequentially and in synchronisation with the line scanning of an image frame. To facilitate multiplexing of the row intensity data onto the correct or the corresponding driver row, actuation or enabling data as shown adjacent the “Row Driver” of FIG. 4 are provided. Referring to FIG. 4, the multiplexing or actuation data are time distributed or allocated in a sequence so that each one of the N intensity data of an intensity data group (1 to M) is sequentially multiplexed to a corresponding driver row.

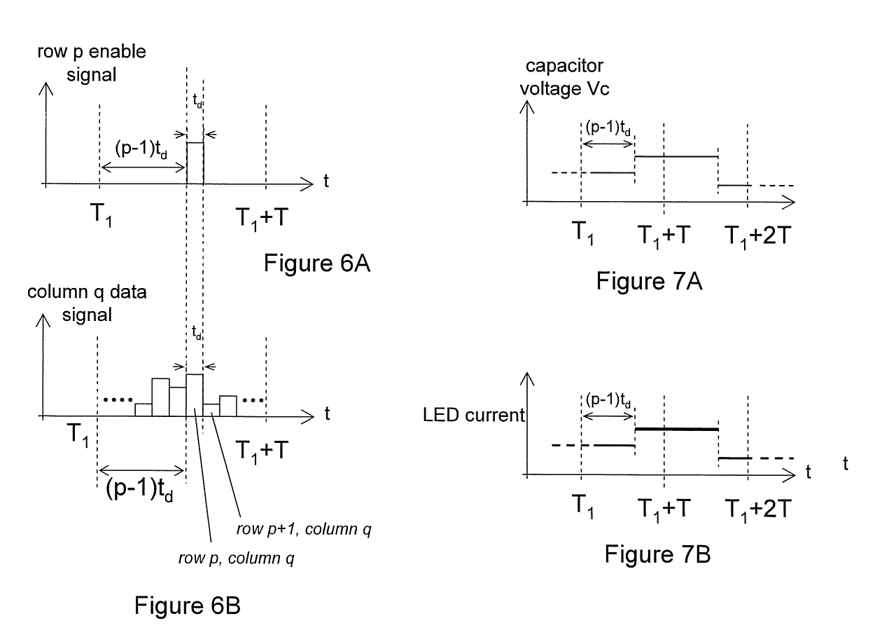

For example, and as shown in FIGS. 6A and 6B, a multiplexing enabling data at a time t_{q} from a reference time T₁ is for multiplexing the q^{th} row intensity signal of the intensity signal data group for intensity of row q drivers.

To extend the lighting persistence of an LED, a capacitive device 170 is connected to the actuation gate of the current source. The capacitive device is arranged so that the voltage at the actuation gate of the FET of the current source is maintained at a desired intensity level for an extended period of time T sufficient to alleviate premature vanishing of an image or excessive flashing for enhanced viewing, as better understood with reference more particularly to FIGS. 7A and 7B.

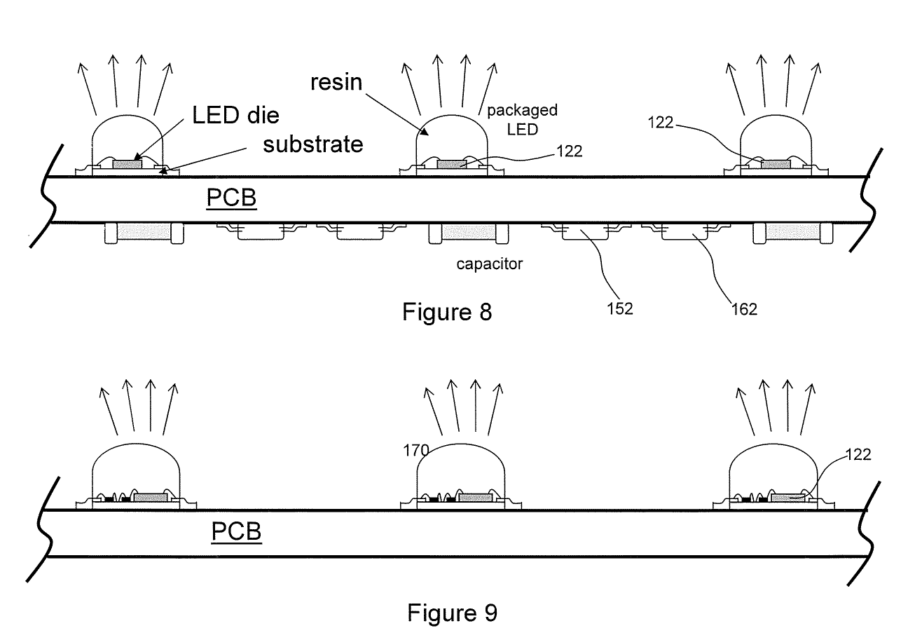

The back-light arrangement of this invention also facilitates the device of a more compact LCD display since only a small number of components is required. For example, in the first exemplary arrangement of FIG. 8, a plurality of packaged LED chips are surface mounted on a forward surface of a printed circuit board, while the current source FET transistor, the semiconductor switch, the capacitor, the row and column rails, and the power supply rails, are disposed on the rearward face of the printed circuit board (PCB). In the Example of FIG. 9, all the components, including the rails, are formed on the front surface of the PCB as a convenient example.

To facilitate individual controlling of the LEDs, and to generate individual intensity data, a video signal analysing device in the form of a data processing unit 220 is provided and as shown in FIG. 1. The video signal analysing device receives an image frame from an image processing unit which is interfaced to an external video source. The image processing unit will then output image data to the LCD display and the pixel brightness data to the data processing unit of a controller. Upon receipt of the pixel brightness data, the controller will then organise the intensity signals in a manner suitable for multiplexing, as depicted above with reference to FIGS. 4, 6A & 6B. More specifically, the controller will process the pixel brightness data of an image frame and then output the brightness or intensity level of each of the M×N pixels or pixel regions to generate intensity signals of an amplitude correlating to the brightness of a particular pixel or pixel region. The intensity signals are then multiplexed by a controlled according to a predetermined time sequence as illustrated above with reference to FIG. 4.

In an alternative configuration, the back-light arrangement is identical to that of the above mentioned arrangement, except that the FET 152 of the current source is configured as a solid state switch. In such a configuration and as shown in FIG. 5, the driver comprises a first solid state switch 152 for connecting the LED to a power source, and the first solid state switch is actuatable or controllable by a second solid state switch 162 which is in series connection with the actuation terminal of the first solid state switch. A capacitive member such as a capacitor is coupled to the actuation terminal of the first solid state switch for extending the actuation duration of the first solid state switch, thereby extending the duration of current flow through the LED.

While the present invention has been explained by reference to the examples or preferred embodiments described above, it will be appreciated that those are examples to assist understanding of the present invention and are not meant to be restrictive. Variations or modifications which are obvious or trivial to persons skilled in the art, as well as improvements made thereon, should be considered as equivalents of this invention.

For example, although the present invention has been explained with reference to an LCD display, the back-light device of this invention would be equally useful for other non-light emitting display members available from time to time.

Furthermore, while the present invention has been explained by reference to using discrete LED chip components as an example of light emitting sources for back lighting, it should be appreciated that the invention can apply, whether with or without modification, to other discrete light emitting devices without loss of generality. Also, although this invention has been illustrated with reference to a LCD display, it should be appreciated that the invention is not limited to LCD displays without loss of generality.

As a further note, although the above embodiments have been explained with reference to a light emitting source each comprising a single light emitting source, such as a white LED, it will be appreciated that each driver may be configured to drive a plurality of light emitting sources having the same colour without loss of generality.

1. A back-light arrangement for providing back-light to a display panel such as a liquid crystal video display panel, comprising
a plurality of light emitting devices arranged and distributed for providing back-light to said display panel;
electronic circuitry arranged for driving said plurality of light emitting devices to produce said back-light, wherein said electronic circuitry comprises a plurality of drivers each one of which is arranged to individually drive a corresponding one of said plurality of light emitting devices to emit light upon receipt of an actuating signal; and
a controller arranged to multiplex an intensity signal to each one of said plurality of drivers for individually driving each one of said plurality of light emitting devices.

2. A back-light arrangement according to claim 1, wherein each said driver comprises a current source which is actuatable by a solid state switch, said solid state switch being actuatable upon receipt of a said actuation signal from said controller.

3. A back-light arrangement according to claim 2, wherein a capacitive member is coupled to said current source, said capacitive member being arranged so that the operation duration of said current source is extendable beyond the duration of said actuation signal.

4. A back-light arrangement according to claim 3, wherein said current source is isolatable from said actuation signal upon deactivation of said solid state switch, said solid state switch having a very high impedance upon de-activation.

5. A back-light arrangement according to claim 4, wherein said current source comprises a transistor which is arranged for supply of a current to said light emit device, and said solid state switch comprises a FET actuatable by said actuation signal, said capacitive member is connected to the gate terminal of said FET of said current source.

6. A back-light arrangement according to claim 3, wherein said light emitting devices are arranged into a matrix of N rows and M columns, N and M being integers; wherein a said light emitting device associated with a row of said matrix is connected to a row rail, and a said light emitting device associated with a column of said matrix is connected to a column rail; and wherein said intensity signals are carried on a said row rail, and said actuation signals are carried on a said column rail.

7. A back-light arrangement according to claim 6, wherein said intensity signals are organised into M intensity signal groups each comprising N intensity signals, said N intensity signals being sequentially allotted at a plurality of pre-determined time slots; and wherein a said intensity signal in a said intensity signal group is multiplexed to an associated said row rail by a said actuation signal on a said column rail.

8. A back-light arrangement according to claim 7, wherein the N said intensity signals of a said intensity signal group are allocated in a time frame t of 1/f, where f is the number of video frames per second.

9. A back-light arrangement according to claim 8, wherein a said intensity signal in a said intensity signal group is allocated a time slot in said time frame; and wherein each said time slot has width T=1/Nf, where f is the number of video frames per second.

10. A back-light arrangement according to claim 8, wherein each intensity signal signal is a square pulse having a pulse width of 1/Nf.

11. A back-light arrangement according to claim 8, wherein said actuation signals are allocated sequentially at predetermined time slots, each said predetermined time slot having a slot width of 1/Nf.

12. A back-light arrangement according to claim 6, wherein said solid state switch comprises an actuating terminal and an input terminal, said actuating terminal being connected to said row rail, and said input terminal being connected to said column rail.

13. A back-light arrangement according to claim 1, wherein the level of current supply of a said driver is controllable by variation of amplitude of a said intensity signal at said driver.

14. A back-light arrangement according to claim 13, wherein the amplitude of each said intensity signal is individually adjustable in response to changes in image intensity distribution on said display panel.

15. A back-light arrangement according to claim 1, further comprising an image intensity analysing device for analysing image intensity distribution information of an image to be displayed on said display panel, wherein said controller adjusts the amplitude of said intensity signals in response to intensity distribution information provided by said image intensity analysing device.

16. A back-light arrangement according to claim 15, wherein a said light emitting device is allocated for back-illumination of a pre-determined portion of said display, and wherein the amplitude of a said intensity signal associated with a said light emitting device increases with the brightness of an image to be displayed on that pre-determined portion of said display panel.

17. A back-light arrangement according to claim 1, wherein said intensity signals are arranged into a plurality of intensity signal groups and each intensity signal group comprises a plurality of intensity signals of non-identical amplitudes arranged in time sequence, and wherein the plurality of intensity signals in an intensity signal group are sequentially multiplexed to said plurality of drivers.

18. A back-light arrangement according to claim 1, wherein the brightness of each one of said plurality of light emitting devices is gradually variable by adjusting the amplitude of a said intensity signal associated with said light emitting device.

19. A back-light arrangement according to claim 1, wherein said drivers are actuated in synchronisation with the line scanning signal of a video image.

20. A back-light arrangement according to claim 1, wherein said intensity signals are time-multiplexed to each one of said plurality of drivers.

21. A back-light arrangement according to claim 1, wherein each light emitting device is configured for back-illumination of a pre-determined portion of said display panel, the brightness level of each said light emitting device being individually controllable by said electronic circuitry responsive to the brightness level of the portion of said display panel being under back-illumination by said light emitting device.

22. A back-light arrangement according to claim 21, wherein said plurality of light illuminating devices is configured for back-illumination a liquid crystal display.

23. A back-light arrangement according to claim 22, wherein each said light emitting device comprises at least one light emitting diode.

24. A back-light arrangement according to claim 23, wherein said plurality of light emitting devices is arranged in a matrix of light emitting diodes.

25. A liquid crystal display comprising a back-light arrangement of claim 1.

26. A back-light arrangement for providing back-light to a display panel such as a liquid crystal video display panel, comprising
a plurality of light emitting devices arranged into an array of a matrix of M columns and N rows, M and N being integers; and
electronic circuitry comprising N row rails and M column rails, wherein said light emitting devices belonging to a row of said matrix is associated with a said row rail and said light emitting devices belonging to a column of said matrix is associated with a column rail, said row rails and said column rails being arranged for transmitting actuation signals to said light emitting devices;
wherein said electronic circuitry further comprises a plurality of solid state switches, each said light emitting device being associated with a first solid state switch and a second solid state switch; wherein said first solid state switch connects said light emitting device to a power source and is actuatable upon receipt of an actuation signal from said second solid state switch, said second solid states switches being actuatable only when actuation signals are present on both a said row rail and a said column associated with said second solid state switch.

27. A back-light arrangement according to claim 26, wherein said first solid state switch is a 3-terminal device comprising an actuation terminal which is connected to an output terminal of said second solid state switch, and wherein a capacitor for extending the actuation duration of said first solid state switch is coupled to said actuation terminal.

28. A back-light arrangement for providing back-light to a display panel such as a liquid crystal video display panel, comprising
a plurality of light emitting devices arranged and distributed for providing back-light to said display panel;
electronic circuitry arranged for driving said plurality of light emitting devices to produce said back-light, wherein said electronic circuitry comprises a plurality of drivers each one of which is arranged to individually drive a corresponding one of said plurality of light emitting devices to emit light upon receipt of an actuating signal, and wherein the brightness of a said light emitting device is controllable by varying the amplitude of said intensity signal; and
a controller arranged to transmit said intensity signal to each one of said plurality of drivers for individually driving each one of said plurality of light emitting devices,
wherein the amplitude of each said intensity signal is individually adjustable in response to changes in image intensity distribution on said display panel.
